(19) United States
(12) Patent Application Publication
(10) Pub. No.: US 2006/0045525 A1
(43) Pub. Date: Mar. 2, 2006

(54) Optical access network of wavelength division method and passive optical network using the same

(75) Inventors: Gyu-Woong Lee, Suwon-si (KR); Seong-Taek Hwang, Pyeongtaek-si (KR); Jae-Hoon Lee, Seoul (KR); Chang-Sup Shim, Seoul (KR); Yun-Je Oh, Yongin-si (KR); Yong-Gyoo Kim, Seoul (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/199,490

(22) Filed: Aug. 8, 2005

(30) Foreign Application Priority Data
Aug. 28, 2004 (KR) 2004-68215
Jul. 8, 2005 (KR) 2005-61585

(51) Int. Cl. H04J 14/00

(52) U.S. Cl. 398/71

(57) ABSTRACT

A wavelength division multiplexed optical access network including a central office for multiplexing first optical signals used for transmitting a high-speed wire data service to a subscriber side and second optical signals used for transmitting a wireless data service to a remote subscriber terminal, a remote node connected to the central office through an optical fiber and for de-multiplexing a multiplexed optical signal received from the central office, a plurality of subscribers connected to the remote node, each subscriber receiving a first optical signal having a corresponding wavelength from among the de-multiplexed first optical signals, and a plurality of radio access units connected to the remote node, each radio access unit converting a second optical signal having a corresponding wavelength from among the de-multiplexed second optical signals into a wireless electric signal and wirelessly transmitting the wireless electric signal.

### CLAIM OF PRIORITY

This application claims priority to an application entitled “Optical Access Network of Wavelength Division Method And Passive Optical Network Using The same,” filed in the Korean Intellectual Property Office on Aug. 28, 2004 and Jul. 8, 2005 and assigned Serial Nos. 2004-68215 and 2005-61585, respectively, the contents of which are incorporated herein by reference.

### BACKGROUND OF THE INVENTION

1. Field of the Invention

The present invention relates to an optical access network, and more particularly to a wavelength division multiplexed optical access network capable of servicing both a wire network and a wireless network.

2. Description of the Related Art

As a demand for more data capability in a wire communication system or a mobile communication system increases, it is necessary for access networks to process data having wider band widths in order to provide various high-capacity multimedia data such as images, moving pictures, as well as voice signals. A wavelength division multiplexed (WDM) passive optical access network has been widely used for processing the wider broadband communication data.

FIG. 1 illustrates a conventional WDM optical access network 100, and FIGS. 2A to 2D are graphical illustration of the WDM optical access network 100 shown in FIG. 1.

As shown in FIG. 1, the conventional WDM optical access network 100 includes a central office (CO) 110 for detecting an upstream optical signal and generating a multiplexed downstream optical signal, a subscriber side 130 for receiving a corresponding downstream optical signal and generating an upstream optical signal, and a remote node (RN) 120 for relaying optical signals between the CO 110 and the subscriber side 130.

The CO 110 includes a plurality of downstream transmitters 111-1 to 111-N for generating wavelength-locked downstream optical signals, a first multiplexer 113 for multiplexing the downstream optical signals, a downstream broadband light source 115 for generating downstream light for wavelength-locking the downstream transmitters 11-1˜111-N, a first de-multiplexer 114 for de-multiplexing multiplexed upstream optical signals, a plurality of upstream detectors 112-1 to 112-N for detecting the corresponding de-multiplexed upstream optical signals, and an upstream broadband light source for generating upstream light for wavelength-locking the subscriber side 130.

The first multiplexer 113 is linked to the RN 120 via a downstream optical fiber 101. The first multiplexer 113 de-multiplexes downstream light, which is input through a first circulator 116, into incoherent channels having their own wavelengths. Then, the first multiplexer 113 allows the de-multiplexed downstream light to be input to the corresponding downstream light sources 111-1 to 111-N. Also, the first multiplexer 113 multiplexes the downstream optical signals and outputs the multiplexed downstream optical signals to the RN 120 through the first circulator 116. The downstream light generated by the downstream broadband light source has a waveform shown in FIG. 2A and is input to the first multiplexer 113 through the first circulator 116. The first multiplexer 113 splits the downstream light to a plurality of incoherent channels having wavelengths in the form shown in FIG. 2B and outputs the split downstream light to corresponding downstream transmitter 111-1˜111-N. The downstream transmitters 111-1 to 111-N may include a Fabri Perrot-Laser Diod (FP-LD) having a multi-mode output characteristic or a semiconductor optical amplifier (SOA). If the downstream transmitters 111-1˜111-N are FP-LDs having the same output characteristic as shown in FIG. 2C, a wavelength-locked downstream signal having a wave form shown in FIG. 2D is generated. In the wavelength-locked downstream signal, only one mode corresponding to an incoherent channel wavelength having a waveform shown in FIG. 2B and being applied to corresponding downstream transmitters 111-1 to 111-N, is output from the multiple modes of the down transmitters 111-1 to 111-N.

The first de-multiplexer 114 is linked to the RN 20 via an upstream optical fiber 102. The first de-multiplexer 114 de-multiplexes multiplexed upstream optical signals input through a second circulator 118 and outputs the multiplexed upstream optical signals to corresponding upstream detectors 112-1 to 112-N. The second circulator 118 is arranged between the RN 120 and the first de-multiplexer 114 and connected to the upstream broadband light source 117, thereby outputting the upstream light to the RN 120.

The RN 120 includes a second de-multiplexer 121 linked to the first multiplexer 113 through the downstream optical fiber 101 and a second multiplexer 122 linked to the first de-multiplexer 114 through the upstream optical fiber 102.

The second de-multiplexer 121 de-multiplexes the multiplexed downstream optical signals and outputs the multiplexed downstream optical signals to the subscriber side 130. The second multiplexer 122 de-multiplexes the upstream light into incoherent channels having their own wavelengths, and outputs the upstream light to the subscriber side 130. The subscriber side 130 multiplexes wavelength-locked upstream optical signals and outputs the wavelength-locked upstream optical signals to the CO 110.

The subscriber side 130 includes a plurality of upstream light sources 132-1 to 132-N linked to the second multiplexer 122 and a plurality of downstream detectors 131-1 to 131-N for detecting corresponding downstream optical signals de-multiplexed by the second de-multiplexer 121.

Each of the upstream light sources 132-1 to 132-N generates an upstream optical signals wavelength-locked by a corresponding incoherent channel and outputs the generated upstream optical signals to the second multiplexer 122.

However, large initial investment costs are required for the above-described optical access network.

In a wireless network, although mobility and point to multi-point connection can be provided, serious loss can occur when limiting bandwidths. To overcome this problem, a radio-over-fiber technique has been proposed.

The radio-over-fiber technique is used for transmitting wireless electric signals (radio frequency) with a predetermined bandwidth through an optical fiber. A radio-over-fiber network includes a central office and a remote node linked with each other through an optical fiber. That is, the central office converts a wireless electric signal into an optical signal and transmits the converted optical signal to a corresponding remote node. The corresponding remote node converts a received optical signal into a wireless electric signal and then transmits the converted wireless electric signal to a neighbor wireless terminal.

The radio-over-fiber network can centralize electrical appliances, which have been distributed to a plurality of remote nodes, in a central office. Therefore, the remote node may include only optical transceivers and remote antenna units and the signals can be transmitted through broadband widths, thus improving the frequency efficiencies.

However, since the conventional WDM optical access network provides services mainly for wire network subscribers, the network requires a large amount of initial costs and costs associated with the maintenance of the network including laying of optical fibers. Similarly, the cost of implementing the radio-over-fiber network is also high. Therefore, the scalability and usage of the radio-over fiber network is restricted

Furthermore, as various types of wireless terminals having different multimedia functions are widely used, the demand for the radio-over-fiber network capable of providing the broad bands and high-speed wireless services has been increased rapidly. However, the drawbacks of radio-over-fiber network, which requires a large amount of initial investment including optical fiber laying costs and time r to construct a dedicated radio-over-fiber network, has prevented the availability of such network.

### SUMMARY OF THE INVENTION

Accordingly, the present invention has been made to solve the above-mentioned problems occurring in the prior art and provides additional advantages, by providing a wavelength division multiplexed optical access network capable of offering broadband services to subscribers of wire and wireless networks at a ultra high speed while lowering the investment costs required for constructing the WDM optical access network.

In one embodiment, there is provided a wavelength division multiplexed optical access network having a central office for multiplexing first optical signals used for transmitting a high-speed wire data service to a subscriber side and second optical signals used for transmitting a wireless data service to a remote subscriber terminal, a remote node coupled to the central office through an optical fiber for de-multiplexing a multiplexed optical signal received from the central office, a plurality of subscribers coupled to the remote node, each subscriber receiving a first optical signal having a corresponding wavelength from among the de-multiplexed first optical signals, and a plurality of wireless relay stations coupled to the remote node, each radio access unit converting a second optical signal having a corresponding wavelength from the de-multiplexed second optical signals into a wireless electric signal and wirelessly transmitting the wireless electric signal.

### BRIEF DESCRIPTION OF THE DRAWINGS

The above features and advantages of the present invention will be more apparent from the following detailed description taken in conjunction with the accompanying drawings, in which:

FIG. 1 illustrates a conventional WDM optical access network;

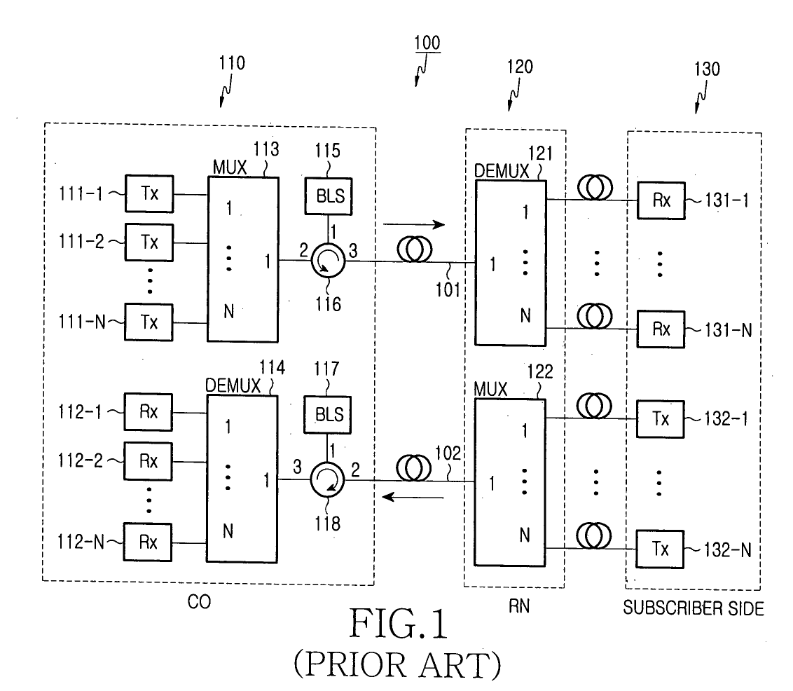

FIGS. 2A to 2D are graphical illustration of the WDM optical access network shown in FIG. 1;

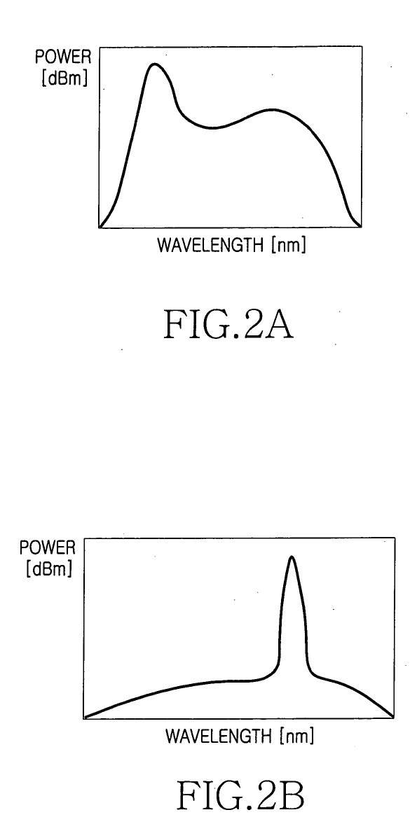

FIG. 3 illustrates a structure of an optical access network according to a first embodiment of the present invention;

FIGS. 4A to 4D are graphical illustration of the optical access network shown in FIG. 3;

FIG. 5A is a block diagram illustrating a structure of an electric-optical converter shown in FIG. 3;

FIG. 5B is a block diagram illustrating the structure of a radio access unit shown in FIG. 3;

FIG. 6 illustrates a structure of a passive optical access network according to a second embodiment of the present invention;

FIGS. 7A and 7B are graphical illustration showing a relationship among a broadband light source, a first band-allocation module, and a second band-allocation module shown in FIG. 6;

FIG. 8 illustrates an example of a radio access unit shown in FIG. 6;

FIG. 9 illustrates an example of a radio access unit shown in FIG. 6;

FIG. 10 is a block diagram illustrating a structure of a passive optical network according to a third embodiment of the present invention;

FIG. 11 is a graph for explaining the signal flow in each component shown in FIG. 10; and

FIG. 12 is a block diagram illustrating an example of the structure of a wireless signal transmitting module shown in FIG. 10.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

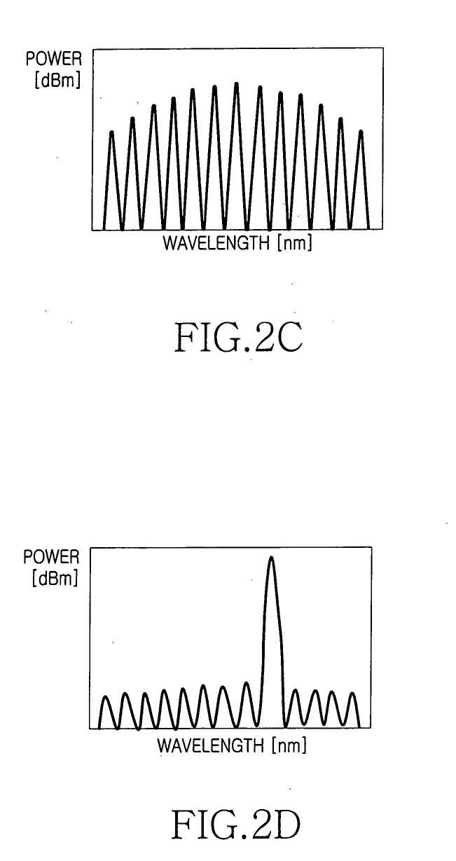

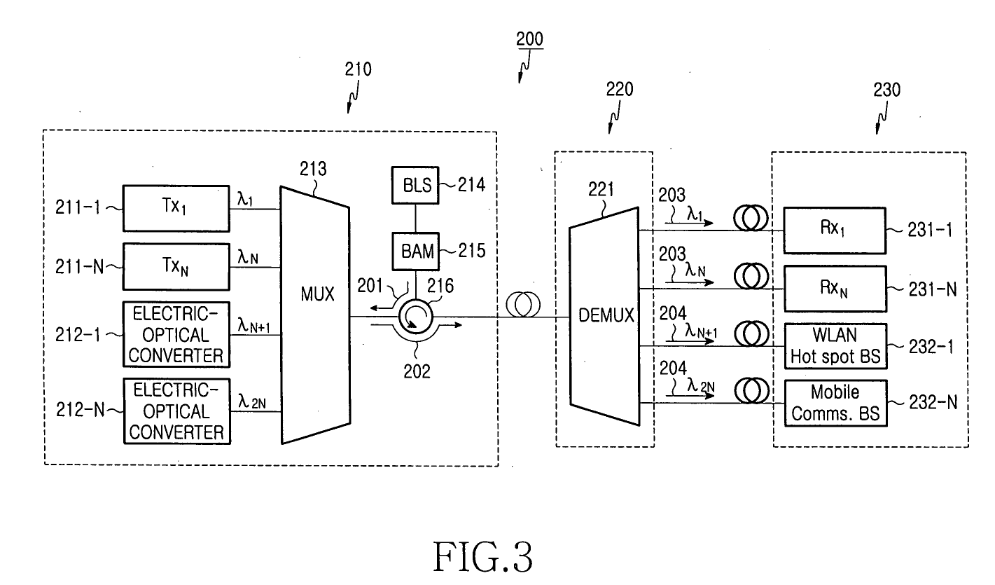

FIG. 3 illustrates the structure of an optical access network according to a first embodiment of the present invention. FIGS. 4A to 4D are graphical illustration of the optical access network shown in FIG. 3.

Referring to FIG. 3, a wavelength division multiplexed (WDM) optical access network 200 according to the first embodiment of the present invention includes a central office (CO) 210 for multiplexing first optical signals 203 used for providing a wire data service at a high speed and second optical signals 204 applied in order to transmit a wireless data service to subscriber terminals, a remote node (RN) 220 for de-multiplexing a multiplexed optical signal 202 received from the CO 210, and a subscriber side 230 for receiving the first optical signals 203 and the second optical signals 204 de-multiplexed in the RN 220. The subscriber side 230 includes a plurality of subscribers 231-1 to 213-N, each of which is connected to the RN 220, and a plurality of radio access units, each of which is connected to the RN 220.

The CO 210 includes a broadband light source 214 for generating light with broadband wavelengths, a band-allocation module 215 for separating an optical wavelength band required for wire data transmission from an optical wavelength band required for wireless signal transmission, a multiplexer 213, a plurality of light sources 211-1 to 211-N for generating wavelength-locked first optical signals 203, a plurality of electric-optical converters 212-1 to 212-N connected to the multiplexer 213 for converting a wireless electric signal into a second optical signal 204 having wireless data of an optical wavelength band blocked by the band-allocation module 215, which is different from optical wavelength bands of wavelength-locked first optical signals directly generated from the broadband light source 214, the multiplexer 213, and the light sources 211-1 to 211-N, and a circulator 216.

The multiplexer 213 multiplexes the first optical signals 203 and the second optical signals 204 and outputs the multiplexed optical signals to the RN 220 through the circulator 216. The multiplexer 213 de-multiplexes the light 201 input through the circulator 216 into a plurality of incoherent channels having their own wavelengths (λ₁ to λ_{N}) and outputs the de-multiplexed light to corresponding light sources 211-1 to 211-N. Each of the light sources 211-1 to 211-N generates the first optical signal 203 wavelength-locked by a corresponding incoherent channel and outputs the first optical signal 203 to the multiplexer 213.

The circulator 216 outputs an optical signal multiplexed by the multiplexer 213 to the RN 220. Also, the circulator 216 outputs the light 201 generated from the broadband light source 214 to the multiplexer 213.

FIGS. 4A to 4D are graphs for explaining the light 201 during operation. The band-allocation module 215 passes the light having only a wavelength band of λ₁ to λ_{N} through the circulator 216. Herein, the wavelength band of λ₁ to λ_{N} is obtained by excluding a wavelength band of λₙ₊₁ to λ_{2N} overlapped with that of the second optical signals from a wavelength band of λ₁ to λ_{2N} of the light generated from the broadband light source 214. Light having the wavelength band of λ₁ to λ_{N} having passed through the band-allocation module 215 is used as a wavelength-locked light source of the TX₁ to TX_{N} 211-1 to 211-N receiving wire data through the multiplexer 213. The wavelength band of λₙ₊₁ to λ_{2N}, which has not passed through the band-allocation module 215, is assigned in order to provide a wireless data service and is used as a wavelength band λₙ₊₁ to λ_{2N} of the second optical signals into which wireless electric signals received in the electric-optical converters 212-1 to 212-N are electro-optically converted.

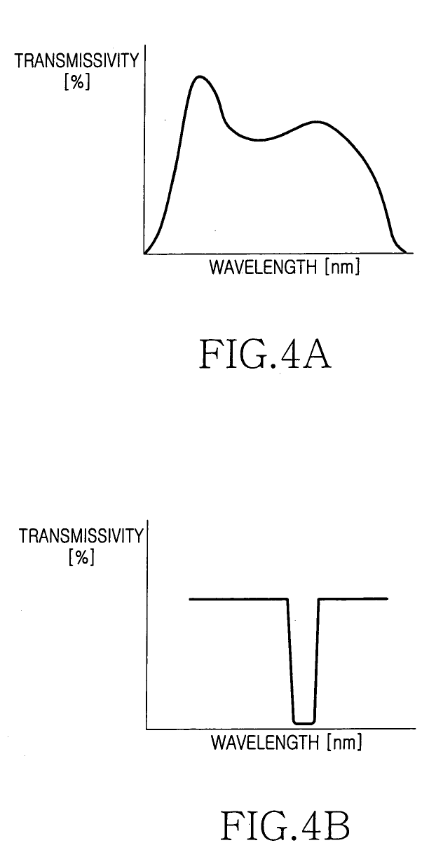

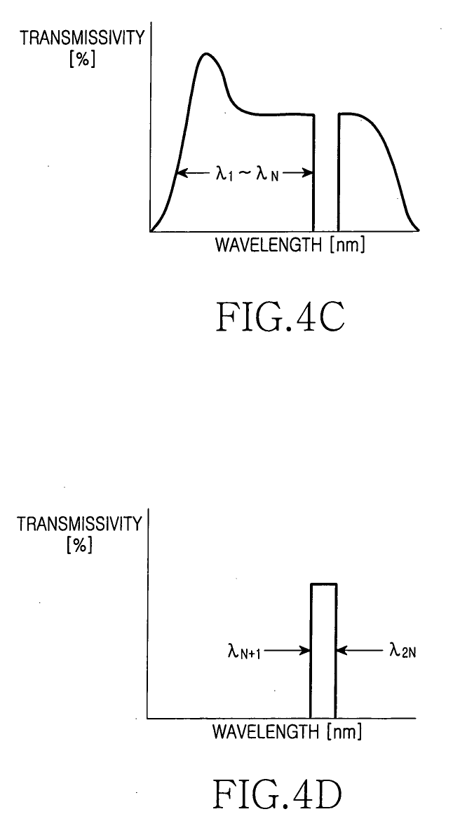

FIG. 5A is a block diagram illustrating the structure of electric-optical converters 212-1 to 212-N shown in FIG. 3. Each of the electric-optical converters 212-1 to 212-N includes an RF converter 212a-N for converting a wavelength band of a wireless electric signal 206 for a wireless data service into a frequency band of the wireless service and an electric-optical converter 212b-N for converting the wireless electric signal 206 output from the RF converter 212a-N into the second optical signal 204 having a wavelength band of λₙ₊₁ to λ_{2N}.

The RF converter 212a-N up-converts baseband wireless transmission data 301 having a predetermined bandwidth into data having a predetermined RF frequency band and outputs a wireless electric signal 303 having the RF frequency band to the electric-optical converter 212b-N. The electric-optical converter 212b-N is an element for converting the wireless electric signal 303 into the second optical signal 204. The electric-optical converter 212b-N can employ a semiconductor laser, a semiconductor optical amplifier, an external optical modulator having a structure of a Mach-Zender interferometer, etc.

The RN 220 includes the de-multiplexer 221 for de-multiplexing an optical signal 202 having been multiplexed in the CO 210 so as to optical transmit the optical signal 202 and then distribute the optical signal to a subscriber side.

Each of the subscribers 231-1 to 231-N is connected to the RN 220 and includes an optical detector for receiving the optical signal per each subscriber after the de-multiplexed first optical signals have been distributed to each subscriber side. The optical detector may include a photo diode.

FIG. 5B is a block diagram illustrating the structure of radio access units 232-1 to 232-N shown in FIG. 3. Each of the radio access units 232-1 to 232-N may include an optical-electric converter 232a-N for converting a second optical signal with a corresponding wavelength from among the de-multiplexed second optical signals 204 into a wireless electric signal and an antenna 232b-N for wirelessly transmitting the wireless electric signal received from the optical-electric converter 232a-N. The optical-electric converter 232a-N may include a photo diode.

The radio access units 232-1 to 232-N may operate as hot-spot base stations for transmitting wireless electric signals to a plurality of terminals including wireless LANs, or base stations for transmitting wireless electric signals to a portable wireless terminal.

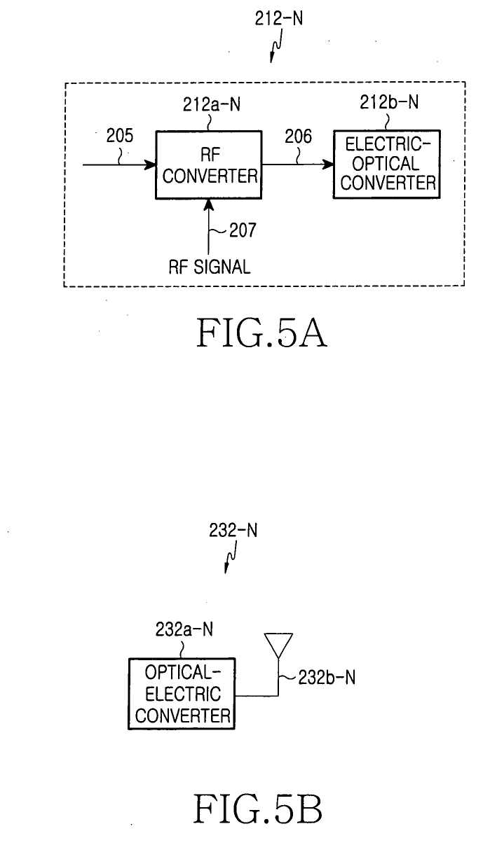

FIG. 6 illustrates the structure of an optical access network according to a second embodiment of the present invention. A passive optical access network 300 for bi-directional communication according to the second embodiment of the present invention includes a central office (CO) 310 for multiplexing first downstream optical signals 301 used for wire data transmission and second downstream optical signals 302 assigned for wireless data transmission, a remote node (RN) 320, connected to the CO 310 through an optical fiber, for de-multiplexing a multiplexed downstream optical signal 303 received from the CO 310, a plurality of subscribers 330-1 to 330-N connected to the RN 320, and a plurality of radio access units 340-1 to 340-N connected to the RN 320.

Each of the subscribers 330-1 to 330-N receives the first downstream optical signal 301 with a corresponding wavelength assigned to each of subscribers 330-1 to 330-N from among the de-multiplexed first downstream optical signals with a wavelength band of λ₁ to λᵢ and outputs a wavelength-locked first upstream optical signal 306 with a wavelength band λₘ₊₁ to λ_{N} to the CO 310 through the RN 320. Each of the radio access units 340-1 to 340-N converts the second optical signal 302 with a corresponding wavelength of λ_{i+!} to λⱼ from among the de-multiplexed second downstream optical signals into a wireless electric signal, wirelessly transmits the converted wireless electric signal, and outputs the second upstream optical signal with a wavelength band of λ_{k+!} to λₘ to the RN 320.

The CO 310 includes a broadband light source 314, a first multiplexer/de-multiplexer 313, a plurality of downstream transmitters 311-1 to 311-N for generating the wavelength-locked first downstream optical signals 301 for wire data transmission, a plurality of electric-optical converters 312-1 to 312-N for generating the second optical signals 302 for wireless data service, a plurality of upstream optical detectors 317-1 to 317-N for detecting corresponding de-multiplexed upstream optical signals 306, wavelength selecting couplers 316-1 to 316-N, an optical coupler 315, a first band-allocation module 318a, and a second band-allocation module 318b.

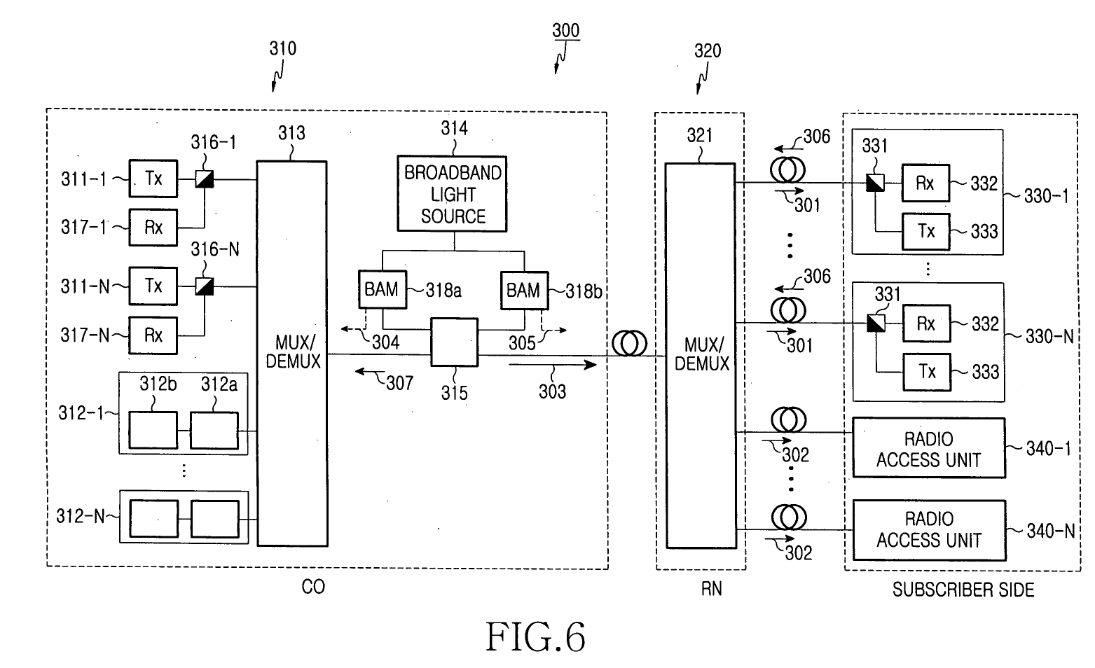

FIGS. 7A and 7B are graphs explaining a relationship between the broadband light source 314, the first band-allocation module 318a, and the second band-allocation module 318b shown in FIG. 6. The broadband light source 314 generates light with a broad wavelength band of λ_{!} to λ_{N}.

The broad wavelength band of λ_{!} to λ_{N} includes a wavelength band of λ₁ to λᵢ for wavelength-locking a downstream optical signal with a wavelength band of λ₁ to λᵢ, a wavelength band of λₘ₊₁ to λ_{N} for wavelength-locking a first upstream optical signal transmitted from each of subscribers 330-1 to 330-N to the CO 310, a wavelength band of λᵢ₊₁ to λⱼ blocked by the first band-allocation module 318a in order to be used as second downstream optical signals downstream-transmitted from the CO 310 to the radio access units 340-1 to 340-N, and a wavelength band of λₖ₊₁ to λₘ blocked by the second band-allocation module in order to be used as second optical signals for upstream transmission from the radio access units 340-1 to 340-N to the central office 310.

The first band-allocation module 318a is arranged between the broadband light source 314 and the optical coupler 315 so as to block a wavelength band of λᵢ₊₁ to λⱼ overlapped with a wavelength band of λᵢ₊₁ to λⱼ of the second optical signal 302 for downstream transmission among a wavelength band of λ_{!} to λ_{N} of the light. In addition, the second band-allocation module 318b is arranged between the broadband light source 314 and the optical coupler 315 and blocks a wavelength band of λₖ₊₁ to λₘ overlapped with a wavelength band of λₖ₊₁ to λₘ of the second optical signal 302 for upstream transmission.

That is, the first band-allocation module 318a and the second band-allocation module 318b suppress noises by preventing the overlap between wavelength bands of λᵢ₊₁ to λⱼ and λₖ₊₁ to λₘ of the second optical signals for upstream and downstream transmission and parts of wavelength bands of light generated from the broadband light source 314.

The first multiplexer/de-multiplexer 313 multiplexes the first downstream optical signals 301 and the second downstream optical signals 302, which are generated from the electric-optical converters 312-1 to 312-N, into downstream optical signals 303 to be output to the RN 320. The first multiplexer/de-multiplexer 313 de-multiplexes upstream optical signals 307 multiplexed in the RN 320 into first and second optical signals so as to output the de-multiplexed upstream optical signals to corresponding upstream optical detectors 317-1 to 317-N or the corresponding electric-optical converters 312-1 to 312-N. Also, the first multiplexer/demulitplexer 313 de-multiplexes the downstream light 304 having a wavelength band of λ₁ to λᵢ input through the optical coupler 315 into a plurality of incoherent channels having mutually different wavelengths and outputs the downstream optical signals to corresponding downstream transmitters 311-1 to 311-N. Each of the downstream transmitters 311-1 to 311-N generates the first optical signal 301 wavelength-locked by a corresponding incoherent channel.

Each of the wavelength selecting couplers 316-1 to 316-N outputs the first optical signal 301 with a wavelength band of λ₁ to λᵢ wavelength-locked by each of the corresponding downstream transmitters 311-1 to 311-N to the first multiplexer/de-multiplexer 313. Also, each of the wavelength selecting couplers 316-1 to 316-N outputs the first and second upstream optical signals de-multiplexed by the first multiplexer/de-multiplexer 313 to each of the corresponding upstream optical detectors 317-1 to 317-N or the electric-optical converters 312-1 to 312-N. The optical coupler 315 is arranged between the first multiplexer/de-multiplexer 313 and the RN 320 and is connected to the broadband light source 314 so that the downstream light 304 is output to the first multiplexer/de-multiplexer 313 and the upstream light 305 is output to the RN 320.

The RN 320 includes a second multiplexer/de-multiplexer 321 for de-multiplexing the multiplexed downstream optical signals 303 in such a manner that each of the first optical signals 301 is output to each of the corresponding subscribers 330-1 to 330-N and each of the second optical signals 302 is output to each of the corresponding radio access units 340-1 to 340-N. Also, the second multiplexer/de-multiplexer 321 multiplexes the first upstream optical signals 306 and the second upstream optical signals input from the subscribers 330-1 to 330-N into upstream optical signals 307 so that the multiplexed upstream optical signals 307 are output to the CO 310. In addition, the second multiplexer/de-multiplexer 321 de-multiplexes the upstream light 305 into a plurality of incoherent channels having mutually different wavelengths in such a manner that the upstream light is output to the corresponding subscribers 330-1 to 330-N.

Each of the subscribers 330-1 to 330-N includes a downstream optical detector 332 for detecting a corresponding first optical signal 301, an upstream light source 333 for generating an upstream optical signal 306 wavelength-locked by a corresponding incoherent channel, and a wavelength selecting coupler 331 for outputting the upstream optical signal 306 to the RN 320 and outputting a corresponding first optical signal 301 received from the RN 320 to the downstream optical detector 332.

The downstream optical detector 332 may include a photo diode. Also, the upstream light source 333 for generating a wavelength-locked upstream optical signal may include a semiconductor optical amplifier or a Febry-Perot laser diode.

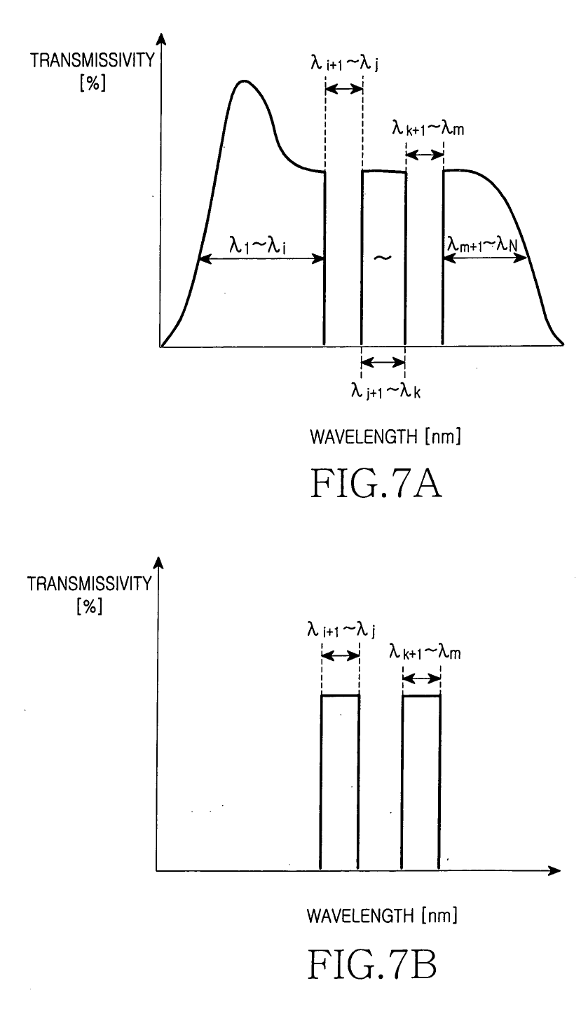

FIG. 8 illustrates an example of each radio access unit 340-N′ shown in FIG. 6. Each radio access unit 340-N′ includes a base station 410 for delivering the second downstream optical signal 302 having a wavelength band of λᵢ₊₁ to λⱼ received from the RN 320 to each terminal over a wireless LAN in a Hot spot and a wireless signal transmitting module 420 used for expanding WLAN services to remote points.

The wireless signal transmitting module 420 includes an optical-electric converter 422 for converting a corresponding second optical signal 302 into a wireless electric signal and an antenna 421 for transmitting the wireless electric signal. The optical-electric converter 422 may include a photo diode. That is, the wireless signal transmitting module 420 converts a corresponding second optical signal (applied to radio access unit 340-N′) input according to the directions of the base station 410 into a wireless electric signal and transmits the wireless electric signal to corresponding portable communication devices 401a, 401b, and 401c including wireless LAN terminals, which are positioned at a neighboring section.

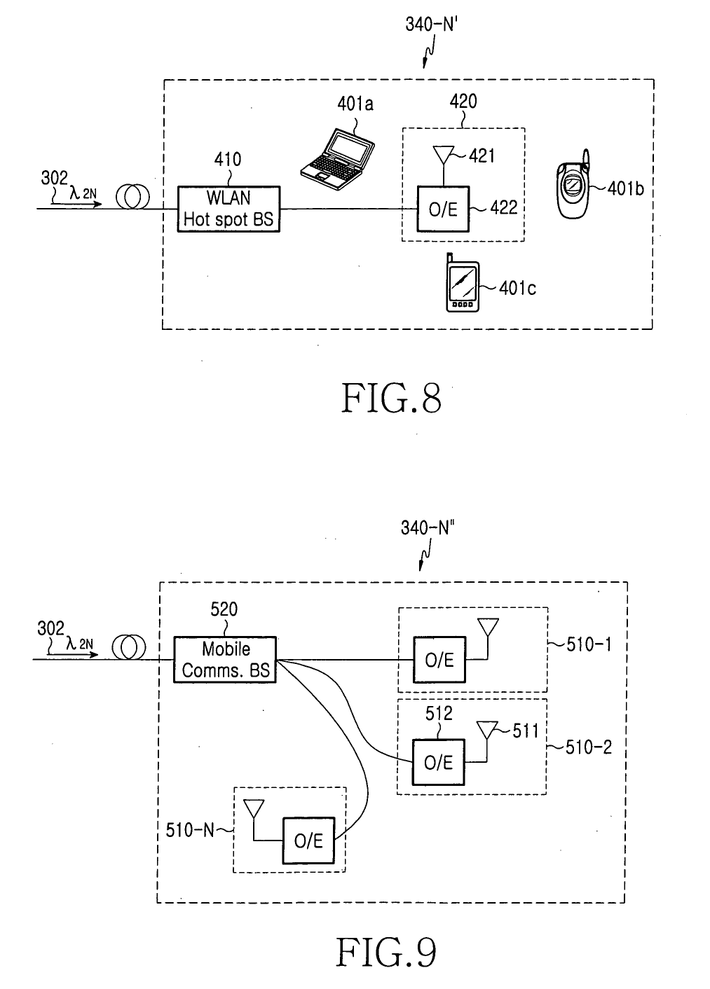

FIG. 9 illustrates an example of a radio access unit 340-N″used for performing a mobile communication service shown in FIG. 6. The radio access unit 340-N″ includes a control module 520 for distribution of a corresponding second optical signal 302 received from the RN 320 and a plurality of wireless signal transmitting modules 510-1 to 510-N connected to the control module 520.

Each of the wireless signal transmitting modules 510-1 to 510-N converts a corresponding second optical signal 302 received from the control module 520 into a wireless electric signal and transmits the a wireless electric signal to a portable wireless terminal positioned at a neighboring section. Also, each of the wireless signal transmitting modules 510-1 to 510-N includes an optical-electric converter 512 for converting a corresponding second optical signal 302 into a wireless electric signal and an antenna 511 for transmitting the wireless electric signal.

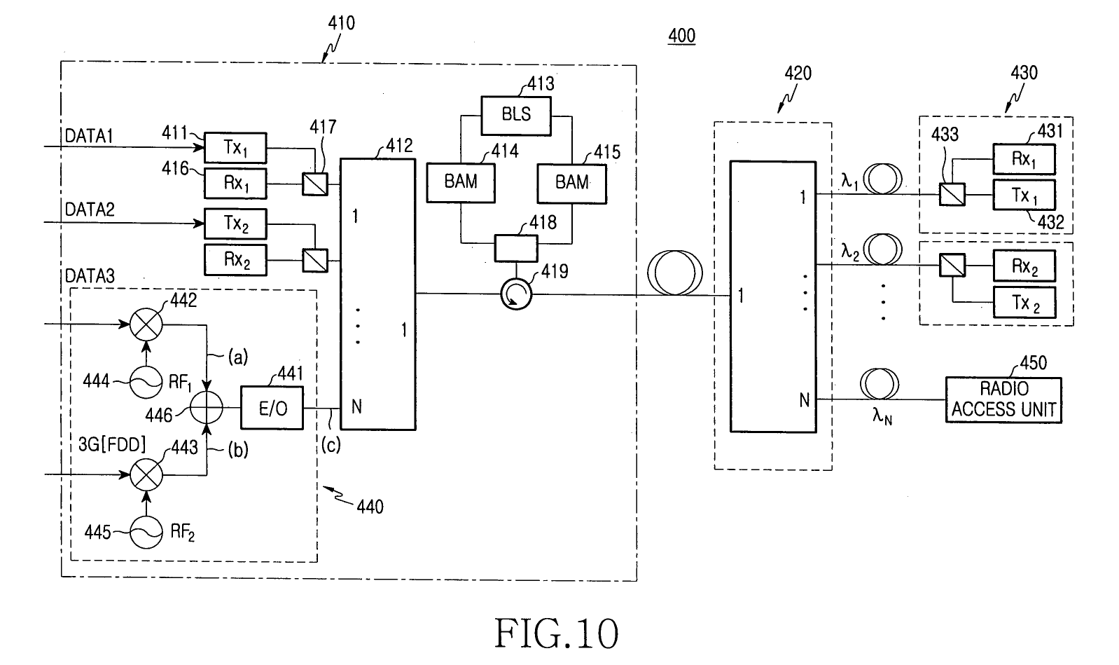

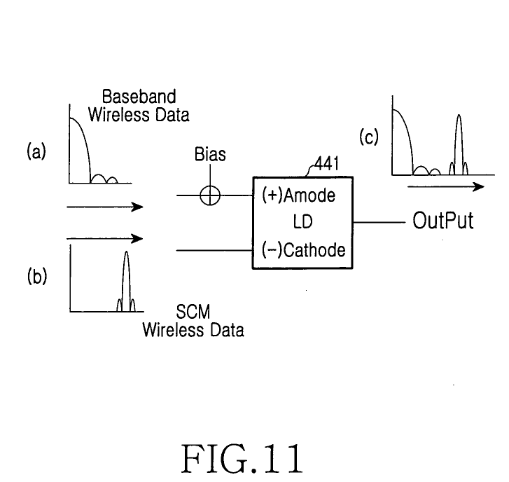

FIG. 10 is a block diagram illustrating the structure of a bi-directional passive optical network according to a third embodiment of the present invention, and FIG. 11 is a graph illustrating a signal flow in each component shown in FIG. 10.

Referring to FIG. 10, a passive optical access network 400 according to the third embodiment of the present invention includes a central office (CO) 410 for multiplexing first downstream optical signals data1 and data2 used for wire data transmission at a high speed and second downstream optical signals used for providing a wireless data service, a remote node (RN) 420 linked to the CO 410, a plurality of subscribers 430 linked to the RN 420, and a plurality of radio access units linked with the RN 420.

The CO 410 multiplexes the first downstream optical signals and the second downstream optical signals into downstream optical signals to be output to the RN 420 and de-multiplexes upstream optical signals multiplexed in the RN 420 to first upstream optical signals and second upstream optical signals. The CO 410 includes a plurality of downstream transmitters 411 Tx₁ and Tx₂ for generating first downstream optical signals used for wire data transmission, a plurality of upstream optical detectors 416 Rx₁ and Rx₂ for detecting first upstream optical signals, a wavelength selecting coupler 417, a broadband light source 413 for generating light having a broad wavelength band, a multiplexer 412 for multiplexing the first downstream optical signals and the second downstream optical signals into downstream optical signals to be output to the RN 420 and for splitting the light according to wavelengths so as to output the split light to corresponding downstream transmitters, an optical signal transmitting module 440 for generating time-division or frequency-division multiplexed second optical signals, a circulator 419 for outputting the light to the multiplexer 412 and for outputting the multiplexed downstream optical signals to the RN 420, an optical coupler 418, and first and second band allocation modules 414 and 415. The first and second band allocation modules 414 and 415 output light having remaining wavelength bands (excluding a wavelength band of the second optical signal from among wavelength bands of the light) to the circulator 419 through the optical coupler 418. The circulator 419 outputs the light to the multiplexer 412 and the RN 420.

The circulator 419 outputs light having a part of wavelength bands of the light generated from the broadband light source 413 to the multiplexer 412 and outputs the multiplexed downstream optical signals to the RN 420. In addition, the RN 420 outputs multiplexed upstream optical signals to the multiplexer 412.

The first band allocation module 414 is arranged between the broadband light source 413 and the optical coupler 418. The first band allocation module 414 blocks a wavelength band overlapped with a wavelength band of the second downstream optical signal among the wavelength bands of light generated from the broadband light source 413 and outputting light having remaining wavelength bands to the optical coupler 418.

The second band allocation module 415 is arranged between the broadband light source 413 and the optical coupler 418. The second band allocation module 415 blocks a wavelength band overlapped with a wavelength band of the second upstream optical signal among the wavelength bands of light generated from the broadband light source 413 and outputting light having remaining wavelength bands to the optical coupler 418.

The second optical signals may include time-divided signals Data 3 through an Ethernet network and frequency-divided wireless signal 3G.

The upstream optical detectors 416 may include a photo diode and detects the first upstream optical signals having corresponding wavelength bands generated from the subscribers 430. In addition, the wavelength selecting coupler 417 outputs the first downstream optical signals generated from the corresponding optical transmitter 411 to the first multiplexer 412 and ouputs the first upstream optical signals from the multiplexer 412 to the corresponding upstream optical detector 416.

The optical signal transmitting module 440 includes a first modulator 442 for modulating a first wireless signal a according to a first carrier signal having a corresponding wavelength, a first wireless signal generator 444 for generating the first wireless signal, a second modulator 443 for modulating a second wireless signal b according to a time-division or frequency-division multiplexed second carrier signal, a second wireless signal generator 445 for generating the second wireless signal b, a conversion 446 for combining the first wireless signal a with the second wireless signal b, and an electric-optical converter 441 for electro optically converting the first wireless signal a and the second wireless signal b into a second optical signal c to be output to the multiplexer 412.

The RN 420 may include an arrayed waveguide grating arranged among the CO 410, the subscribers 430, and a radio access units 450, which de-multiplexes downstream optical signals received therein from the CO 410 so as to output the de-multiplexed upstream optical signals to the corresponding subscribers 430 and the corresponding radio access units 450 and multiplexes the first upstream optical signals and the second upstream optical signals to upstream optical signals to be output to the CO 410.

Each of the subscribers 430 includes a downstream optical detector 431 for receiving a first optical signal having a corresponding wavelength from among the first downstream optical signals de-multiplexed in the RN 420, an upstream optical transmitter 432 for generating a first upstream optical signal, and a wavelength selecting coupler 433.

Each of the radio access units 450 includes a wireless signal transmitting module 451 for converting a second optical signal having a corresponding wavelength from among the de-multiplexed second optical signals into a wireless electric signal and an antenna 452 for transmitting the wireless electric signal to portable wireless terminals around the antenna 452.

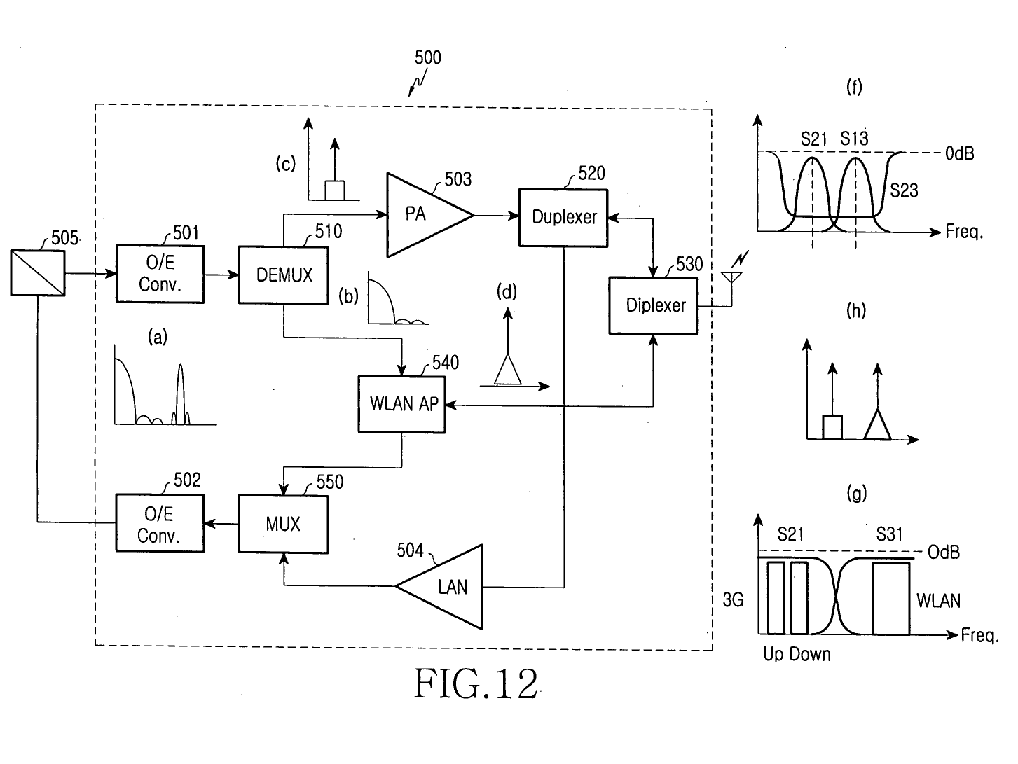

FIG. 12 is a block diagram illustrating an example of the structure of a wireless signal transmitting module shown in FIG. 10.

A wireless signal transmitting module 500 includes an optical-electric converter 501 for converting the corresponding second downstream optical signal a into a wireless electric signal, a wireless signal de-multiplexer 510 for dividing the wireless electric signal into a wireless communication signal c and a wireless LAN signal b to be output, a power amplifier 503 for amplifying the wireless communication signal c, a diplex module 530 for distinguishing the wireless communication signal c and the wireless LAN signal b, a duplex module 520 arranged between the diplex module 530 and the power amplifier 503 for determining if the wireless communication signal c is an uplink signal or a downlink signal, a wireless LAN converter 540 for converting the wireless LAN signal received from a wireless signal de-multiplexer 510 and the diplex module into a signal with a frequency band of 2.4 GHz and transmitting the converted signal through the diplex module, a wireless LAN signal amplifier 504 for amplifying the wireless LAN signal b input thereto from the duplex module 520, a wireless LAN signal multiplexer 550 for multiplexing and upstream transmitting the wireless LAN signal b input thereto from the wireless LAN signal amplifier 504 and the wireless LAN converter 540, an electric-optical converter 501 for converting the wireless LAN signal into the second upstream optical signal, and a wavelength selection coupler 505 for connecting the electric-optical converter 502 and the optical-electric converter 501 to the remote node 420.

As described above, according to the present invention, a wavelength division multiplexed passive optical access network is integrated with a radio-over-fiber network for providing wireless services, thereby enabling subscribers in a wireless network to receive ultra high speed broadband services without separately constructing a radio-over-fiber network. According to the teachings of the invention, it is possible to reduce costs required for constructing the radio-over-fiber network and time required for expansion of the radio-over-fiber network. Also, the limited wire network market is integrated with the rapidly-extending wireless network market, thereby enabling service providers to have improved profitability. Therefore, it is possible to provide services to subscribers at a reduced cost.

Furthermore, in the passive optical access network having a wire network integrated with a wireless network, the maintenance and management for the wire network is integrated with that of the wireless network, thereby enabling costs required for the maintenance and management to be reduced.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A wavelength division multiplexed optical access network, comprising:
a central office for multiplexing first optical signals for wire communication and second optical signals for wireless communication;
a remote node, coupled to the central office via an optical fiber, for de-multiplexing a multiplexed optical signal received from the central office;
a plurality of subscribers coupled to the remote node, each subscriber receiving a first optical signal having a corresponding wavelength from the de-multiplexed first optical signals; and
a plurality of radio access units coupled to the remote node, each radio access unit converting a second optical signal having a corresponding wavelength from the de-multiplexed second optical signals into a wireless electric signal and wirelessly transmitting the wireless electric signal.

2. The wavelength division multiplexed optical access network as claimed in claim 1, wherein the central office comprises a broadband light source for generating light with a broadband wavelength, a multiplexer for multiplexing the first optical signals and the second optical signals and for de-multiplexing the light into a plurality of incoherent channels, each incoherent channel having each wavelength, a plurality of light sources coupled to the multiplexer for generating a first optical signal wavelength-locked by a corresponding incoherent channel, a plurality of electric-optical converters coupled to the multiplexer for converting a wireless electric signal into a second optical signal, and a circulator for outputting an optical signal multiplexed by the multiplexer to the remote node and for outputting the light input from the broadband light source to the multiplexer.

3. The wavelength division multiplexed optical access network as claimed in claim 2, wherein the central office further comprises a band-allocation module disposed between the circulator and the broadband light source, and the band-allocation module passing light having a wavelength band through the circulator, the wavelength band obtained by excluding a wavelength band overlapped with a wavelength band of the second optical signals from a wavelength band of the light input from the broadband light source.

4. The wavelength division multiplexed optical access network as claimed in claim 1, wherein the remote node comprises a de-multiplexer for de-multiplexing optical signals multiplexed in the central office.

5. The wavelength division multiplexed optical access network as claimed in claim 1, wherein each subscriber is coupled to the remote node and comprises an optical detector for receiving a first optical signal having a corresponding wavelength from the de-multiplexed first optical signals.

6. The wavelength division multiplexed optical access network as claimed in claim 1, wherein each radio access unit comprises an optical-electric converter for converting a second optical signal having a corresponding wavelength from among the de-multiplexed second optical signals into a wireless electric signal, and an antenna for wirelessly transmitting the wireless electric signal input from the optical-electric converter.

7. The wavelength division multiplexed optical access network as claimed in claim 2, wherein the electric-optical converter comprises an RF conterver for generating a wireless electric signal with an RF frequency band into which an electric signal with a baseband is converted, and an electric-optical converter for converting the wireless electric signal into a second optical signal.

8. The wavelength division multiplexed optical access network as claimed in claim 6, wherein the optical-electric converter comprises a photo diode for detecting a corresponding second optical signal.

9. The wavelength division multiplexed optical access network as claimed in claim 7, wherein the electric-optical converter comprises a semiconductor laser for converting a corresponding wireless electric signal into a second optical signal.

10. The wavelength division multiplexed optical access network as claimed in claim 7, wherein the electric-optical converter comprises an external modulator for converting a corresponding wireless electric signal into a second optical signal.

11. A passive optical access network employing a wavelength locking method, the passive optical access network comprising:
a central office for multiplexing first downstream optical signals for wire communication and second downstream optical signals for wireless communication into downstream optical signals to be output;
a remote node, coupled to the central office via an optical fiber, for de-multiplexing a multiplexed downstream optical signal received from the central office, the remote node outputting multiplexed upstream optical signals to the central office;
a plurality of subscribers coupled to the remote node, each subscriber receiving the de-multiplexed first optical signal having a corresponding wavelength from the de-multiplexed first optical signals and outputting a wavelength-locked upstream optical signal to the central office through the remote node; and
a plurality of radio access units coupled to the remote node, each radio access unit converting a second optical signal having a corresponding wavelength from among the de-multiplexed second optical signals into a wireless electric signal and wirelessly transmitting the wireless electric signal.

12. The passive optical access network as claimed in claim 11, wherein the central office comprises a broadband light source for generating light with a broad wavelength band, a first multiplexer/de-multiplexer for multiplexing the first optical signal and the second optical signal into a downstream optical signal in such a manner that the downstream optical signal is output to the remote node and for de-multiplexing the upstream optical signals, a plurality of downstream transmitters for generating first downstream optical signals, a plurality of electric-optical converters for generating second downstream optical signals, and a plurality of upstream optical detectors for detecting corresponding upstream optical signals de-multiplexed by the first multiplexer/de-multiplexer.

13. The passive optical access network as claimed in claim 12, wherein the central office comprises a plurality of wavelength selecting couplers for outputting a first optical signal generated by a corresponding downstream light source to the first multiplexer/de-multiplexer and outputting a corresponding upstream optical signal de-multiplexed by the first multiplexer/de-multiplexer to a corresponding upstream optical detector, an optical coupler disposed between the first multiplexer/de-multiplexer and the remote node so that a multiplexed downstream optical signal with an RF frequency band is output to the remote node and a multiplexed upstream optical signal is output to the first multiplexer/de-multiplexer, a first band-allocation module for outputting downstream light having a predetermined wavelength band to the first multiplexer/de-multiplexer through the optical coupler, the predetermined wavelength band not overlapped with a wavelength band of the second optical signal in a wavelength band of the light generated from the broadband light source, and a second band-allocation module for outputting upstream light having only a predetermined wavelength band to the remote node through the optical coupler, the predetermined wavelength band not overlapped with a wavelength band of the second optical signal in a wavelength band of the light generated from the broadband light source.

14. The passive optical access network as claimed in claim 11, wherein the remote node comprises a second multiplexer/de-multiplexer for de-multiplexing the multiplexed downstream optical signals in such a manner that each first downstream optical signal is output to a corresponding subscriber and each second downstream optical signal is output to a corresponding wireless signal generator and for multiplexing upstream optical signals input from the subscribers in such a manner that the multiplexed upstream optical signals are output to the central office, and the second multiplexer/de-multiplexer de-multiplexes the upstream light into a plurality of incoherent channels for performing wavelength locking with respect to each subscriber.

15. The passive optical access network as claimed in claim 11, wherein each subscriber comprises a downstream optical detector for detecting a corresponding first downstream optical signal, an upstream light source for generating a wavelength-locked first upstream optical signal, and a wavelength selecting coupler for outputting the first upstream optical signal to the remote node and outputting a corresponding first downstream optical signal input from the remote node to the downstream optical detector.

16. The passive optical access network as claimed in claim 11, wherein each radio access unit comprises a base station for controlling a distribution of a corresponding second downstream optical signal input from the remote node, and a wireless signal transmitting module for converting a corresponding second optical signal input according to directions of the base station into a wireless electric signal and transmitting the wireless electric signal to a corresponding wireless LAN terminal positioned at a neighboring section.

17. The passive optical access network as claimed in claim 16, wherein the wireless signal transmitting module comprises an optical-electric converter for converting a corresponding second optical signal into a wireless electric signal, and an antenna for transmitting the wireless electric signal.

18. The passive optical access network as claimed in claim 17, wherein the optical-electric converter comprises a photo diode.

19. The passive optical access network as claimed in claim 11, wherein each radio access unit comprises a base station for controlling distribution of a corresponding second downstream optical signal input from the remote node, and a plurality of wireless signal transmitting modules coupled to the base station, and each wireless signal transmitting module converts a corresponding second optical signal input from the base station into a wireless electric signal and transmits the wireless electric signal to a portable wireless terminal positioned at a neighboring section.

20. The passive optical access network as claimed in claim 19, wherein the wireless signal transmitting module comprises an optical-electric converter for converting a corresponding second optical signal into a wireless electric signal, and an antenna for transmitting the wireless electric signal.

21. The passive optical access network as claimed in claim 11, wherein the central office comprises a plurality of downstream transmitters for generating wavelength-locked first downstream optical signals for wire communication, upstream optical detectors for detecting first upstream optical signals having corresponding wavelengths, a broadband light source for generating light having a broadband wavelength band, a multiplexer for multiplexing the first and second optical signals into the downstream optical signals to be output to the remote node, the multiplexer dividing the light according to wavelengths and outputting the divided light to a corresponding downstream transmitter, a wavelength selecting coupler for connecting each upstream optical detector and each downstream transmitter with the multiplexer, an optical transmission module for generating a time-division or frequency-division multiplexed second optical signal, an optical coupler for outputting the light to the multiplexer and outputting the multiplexed downstream optical signal to the remote node, a first band allocation module for blocking a wavelength band overlapped with a wavelength band of the second downstream optical signal among wavelength bands of light generated from the broadband light source and outputting light having remaining wavelength bands to the optical coupler, and a second band allocation module for blocking a wavelength band overlapped with a wavelength band of the second upstream optical signal among wavelength bands of light generated from the broadband light source and outputting light having remaining wavelength bands to the optical coupler.

22. The passive optical access network as claimed in claim 21, wherein the optical transmission module comprises a first modulator for modulating a first wireless signal according to a first carrier signal having a corresponding wavelength, a first wireless signal generator for generating the first wireless signal, a second modulator for modulating a second wireless signal according to a time-division or frequency-division multiplexed second carrier signal, a second wireless signal generator for generating the second wireless signal, a conversion module for combining the first wireless signal with the second wireless signal, and an electric-optical converter for electric-optical converting the first wireless signal and the second wireless signal into a second optical signal to be output to the multiplexer.

23. The passive optical access network as claimed in claim 11, wherein each radio access unit comprises a wireless signal transmitting module for converting the corresponding second downstream optical signal into a wireless electric signal, and an antenna for transmitting the wireless electric signal to portable wireless terminals positioned around the antenna.

24. The passive optical access network as claimed in claim 23, wherein each wireless signal transmitting module comprises an optical-electric converter for converting the corresponding second downstream optical signal into a wireless electric signal, a wireless signal de-multiplexer for dividing the wireless electric signal into a wireless communication signal and a wireless LAN signal and outputting the wireless communication signal and the wireless LAN signal, a power amplifier for amplifying the wireless communication signal, a diplex module for distinguishing the wireless communication signal and the wireless LAN signal, a duplex module for determining if the wireless communication signal is an uplink signal or a downlink signal, the duplex module being arranged between the diplex module and the power amplifier, and a wireless LAN converter for converting the wireless LAN signal received from the wireless signal de-multiplexer and the diplex module into a signal with a frequency band of 2.4 GHz and transmitting the converted signal through the diplex module.

25. The passive optical access network as claimed in claim 24, wherein the wireless signal transmitting module further comprises a wireless LAN signal amplifier for amplifying the wireless LAN signal input thereto from the duplex module, a wireless LAN signal multiplexer for multiplexing and upstream transmitting the wireless LAN signal input thereto from the wireless LAN signal amplifier and the wireless LAN converter, an electric-optical converter for converting the wireless LAN signal into the second upstream optical signal, and a wavelength selecting coupler for connecting the electric-optical converter and the optical-electric converter to the remote node.
